(19) United States
(12) Patent Application Publication
(10) Pub. No.: US 2009/0055650 A1
(43) Pub. Date: Feb. 26, 2009

(54) CONTENT PLAYBACK DEVICE, CONTENT PLAYBACK METHOD, CONTENT PLAYBACK PROGRAM, AND INTEGRATED CIRCUIT

(76) Inventor: Toshihisa NAKANO, Frankfurt am Main (DE)

Correspondence Address: WENDEROTH, LIND & PONACK L.L.P., 2033 K. STREET, NW, SUITE 800, WASHINGTON, DC, 20006, US

(21) Appl. No.: 12/179,953

(22) Filed: Jul. 25, 2008

(30) Foreign Application Priority Data
Jul. 27, 2007 (JP) 2007-195856

(51) Int. Cl. H04L 9/00

(52) U.S. Cl. 713/176

(57) ABSTRACT

When a plurality of types of copyright information are detected on a disk or the like, a content playback device and method can appropriately control playback of content in accordance with the copyright information. As the content playback device, a digital watermark detection device attempts to detect watermark information in blocks that make up the content, and a result storage subunit (401) stores result information constituted from detected watermark information and frequency information indicating how often the watermarks appear. Each time watermark information is detected in one of the blocks, a comparison subunit (402) compares the detected watermark information to the watermark information in the result information, and judges whether updating the result information is necessary with reference to a predetermined condition. An update subunit (403) performs an update, and a control unit (307) performs a playback restriction of the content with use of the result information.

This application is based on application No. 2007-195856 filed in Japan, the content of which is hereby incorporated by reference.

### BACKGROUND OF INVENTION

1. Field of the Invention

The present invention relates to restricting playback of unauthorized copies of digital content such as movies and music, and in particular to technology that uses digital watermarks.

2. Description of the Related Art

In recent years, digital watermarks have been used for protecting copyrighted works from unauthorized copying, etc. performed without the permission of the copyright holder.

A common system using digital watermarks is constituted from a digital watermark embedding device that is a terminal used by a content provider, and a content playback device for playing back the content in which digital watermarks have been embedded.

Patent document 1 discloses a system for detecting unauthorized copies and restricting playback of content in the unauthorized copies by embedding copy control information in the content with use of digital watermark technology.

In this system, the digital watermark embedding device embeds copyright information, etc. in the content, and stores the content on a recording medium such as a disk.

Here, if the content stored on the recording medium is copied in an unauthorized manner, the copyright information embedded in the content is also copied at the same time.

When playing back content that was copied in an unauthorized manner on the recording medium, the content playback device detects the copyright information in the content, displays a warning based on the detected copyright information, and performs a playback restriction such as stopping the playback.

However, the above conventional technology only anticipates a case of detecting one type of copyright information on a disk, and does not anticipate detecting a plurality of types of copyright information.

For example, when children's birthday parties, athletic meets and the like are captured with a camcorder and a plurality of captured videos are collected together on a single disk, a plurality of scenes are included on the disk, and there is a possibility of a plurality of types of copyright information being detected.

Also, a plurality of types of copyright information may be detected on one disk if a pirated disk is made that includes a plurality of types of content, for example.

In the conventional playback terminal, if a plurality of types of copyright information are detected when such a disk is played back, there are cases of the playback terminal malfunctioning, for example by continuing to perform playback control according to previously detected copyright protection information, even after new copyright protection information has been detected.

In view of this, an aim of the present invention is to provide a digital watermark detection device and method for appropriately performing playback control of content according to copyright information when a plurality of types of copyright information are detected on a disk or the like.

Patent document 1: U.S. Pat. No. 5,943,422

### SUMMARY OF INVENTION

In order to solve the above problems, one aspect of the present invention is a content playback device that controls playback of a content having embedded therein a plurality of watermark information pieces, each type of watermark information piece corresponding with each of a plurality of predetermined playback restrictions, the content playback device including a detection unit operable to detect a watermark information piece in the content; a storage unit operable to store therein a history of detection results for a type of watermark information; a control unit operable to execute a playback restriction corresponding to a type of watermark information piece for which a stored history of detection results satisfies a predetermined condition; a judgment unit operable to, in a case that a watermark information piece has been detected, compare an extent of the playback restriction corresponding to a type of the currently detected watermark information piece to an extent of the playback restriction corresponding to the type of watermark information piece for which the history of detection results has been stored, and to judge, based on a result of the comparison, whether or not a detection result for the currently detected watermark information piece is to be stored in the storage unit; and an update unit operable to, when the judgment unit judges affirmatively, store the detection result for the currently detected watermark information piece in the storage unit.

According to this structure, when watermark information is detected that corresponds to a different playback restriction from the current playback restriction during playback control of the content, the content playback device of this aspect of the present invention can select a detection result for watermark information pertaining to a more appropriate extent of playback restriction by comparing the extent of the playback restriction pertaining to the detected watermark information piece to the extent of the current playback restriction. Accordingly, playback control of the content can be performed appropriately.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a block diagram of a structure of a digital watermark embedding/detection system according to embodiment 1;

FIG. 2 is a block diagram of a structure of an embedding device according to embodiment 1;

FIG. 3 is a block diagram of a structure of a detection device according to embodiment 1;

FIG. 4 is a block diagram showing a structure of a judgment unit of the digital watermark detection device according to embodiment 1;

FIG. 5A shows an example of content that has watermark information embedded therein according to embodiment 1, and FIG. 5B shows transitions in storing result information according to embodiment 1;

FIG. 6 shows operations in digital watermark embedding processing according to embodiment 1;

FIG. 7 shows operations in digital watermark detection processing according to embodiment 1 (continued in FIG. 8);

FIG. 8 shows operations in digital watermark detection processing according to embodiment 1;

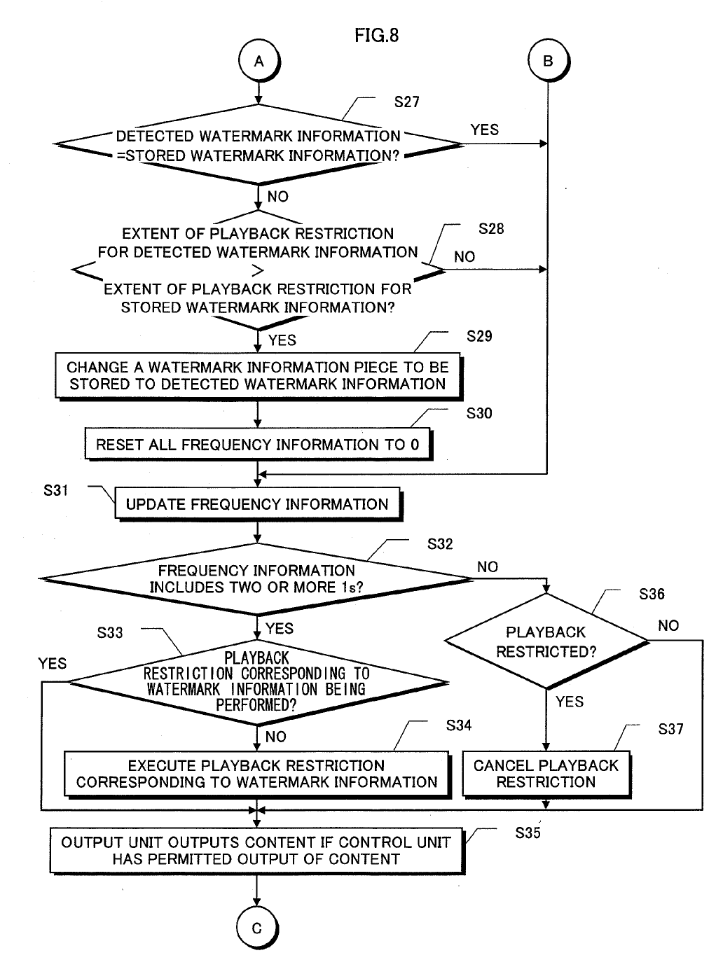

FIG. 9 is a block diagram showing a structure of a judgment unit of a digital watermark detection device according to embodiment 2;

FIG. 10A shows an example of content that has watermark information embedded therein according to embodiment 2, FIG. 10B shows exemplary result information according to embodiment 2, and FIG. 10C shows other exemplary result information according to embodiment 2;

FIG. 11 shows a structure of an LSI that realizes a function of detecting watermark information according to embodiment 1; and

FIG. 12 shows an exemplary operation restriction table indicating restriction operations corresponding to watermark information pieces.

### DESCRIPTION OF THE PREFERRED EMBODIMENTS

One aspect of the content playback device of the present invention is a content playback device that controls playback of a content having embedded therein a plurality of watermark information pieces, each type of watermark information piece 16 corresponding with each of a plurality of predetermined playback restrictions, the content playback device including a detection unit operable to detect a watermark information piece in the content; a storage unit operable to store therein a history of detection results for a type of watermark information; a control unit operable to execute a playback restriction corresponding to a type of watermark information piece for which a stored history of detection results satisfies a predetermined condition; a judgment unit operable to, in a case that a watermark information piece has been detected, compare an extent of the playback restriction corresponding to a type of the currently detected watermark information piece to an extent of the playback restriction corresponding to the type of watermark information piece for which the history of detection results has been stored, and to judge, based on a result of the comparison, whether or not a detection result for the currently detected watermark information piece is to be stored in the storage unit; and an update unit operable to, when the judgment unit judges affirmatively, store the detection result for the currently detected watermark information piece in the storage unit.

Also, the judgment unit may judge that the detection result for the currently detected watermark information piece is to be stored in the storage unit when the extent of the playback restriction corresponding to the type of the currently detected watermark information piece is stricter than the extent of the playback restriction corresponding to the type of watermark information piece for which the history of detection results has been stored in the storage unit.

According to this structure, stricter restrictions can be performed in playback control of the content, and copyrights can be protected more strictly.

Also, each watermark information piece may be in correspondence with a priority, and the judgment unit may judge that the detection result for the currently detected watermark information piece is to be stored when a priority of the currently detected watermark information piece is greater than a priority of the playback restriction corresponding to the type of watermark information piece for which the history of detection results has been stored, regardless of the extent of the playback restriction corresponding to the type of the currently detected watermark information piece.

According to this structure, playback control of the content can be performed with use of a restriction having a higher priority, and copyrights can be appropriately protected.

Also, the judgment unit may judge that the detection result for the currently detected watermark information piece is to be stored when the extent of the playback restriction corresponding to the type of the currently detected watermark information piece is different from the extent of the playback restriction corresponding to the type of watermark information piece for which the history of detection results has been stored in the storage unit.

According to this structure, since the most recently indicated restriction extent is used, content playback can be performed so as to strongly reflect the intentions of the embedded of the watermark information.

Also, the update unit may be further operable to, when a watermark information piece for a stored detection result is different from the currently detected watermark information piece, delete the stored detection result, and store the detection result for the currently detected watermark information piece.

According to this structure, since detection results pertaining to different types of watermark information are stored together, errors in selecting a method of playback restriction pertaining to the detection results can be avoided, and playback restriction of the content can be performed in accordance with an appropriate restriction method.

Also, the content may be constituted from a plurality of blocks, the detection unit may be further operable to judge for each block, in a playback order of the plurality of blocks, whether a watermark information piece has been embedded, and the update unit may store, as detection results, a judgment result for each block indicating whether a watermark information piece has been embedded.

According to this structure, content playback control can be performed using a control method indicated by the entire history, instead of being based on only one detection result among the restriction information.

Also, the control unit may execute a playback restriction corresponding to the type of watermark information piece when greater than or equal to a predetermined percentage of the judgment results show that the watermark information piece has been embedded.

According to this structure, playback control of the content can be performed with use of a restriction method indicated by the judgment results as a whole that are stored as the detection results.

Also, the storage unit may store a plurality of detection results for a plurality of watermark information pieces, the update unit may be further operable to additionally store, in the storage unit, the detection result for the currently detected watermark information piece when the judgment unit judges that the detection result for the currently detected watermark information piece is to be stored, and the control unit may be further operable to determine a playback restriction to execute, among the plurality of playback restrictions, in accordance with the plurality of detection results for the plurality of watermark information pieces stored in the storage unit.

Since detection results for a plurality of types of watermark information are stored rather than only one type, this structure enables preventing detected detection results from not being reflected in playback restriction, and being ignored.

Therefore, this structure enables selecting and using an appropriate restriction method or using a plurality of restriction methods simultaneously, from among restriction methods corresponding respectively to the plurality of watermark information pieces.

The content playback method is a content playback method for controlling playback of content having embedded therein a plurality of watermark information pieces, each type of watermark information piece corresponding with each of a plurality of predetermined playback restrictions, the content playback method including the steps of: detecting a watermark information piece in the content; storing a history of detection results for a type of watermark information; executing a playback restriction corresponding to a type of watermark information piece for which a stored history of detection results satisfies a predetermined condition; comparing, in a case that a watermark information piece has been detected, an extent of the playback restriction corresponding to a type of the currently detected watermark information piece to an extent of the playback restriction corresponding to the type of watermark information piece for which the history of detection results has been stored, and judging, based on a result of the comparison, whether a detection result for the currently detected watermark information piece is to be stored in the storage unit; and when the judgment unit judges affirmatively, storing the detection result for the currently detected watermark information piece in the storage unit.

The content playback program is a content playback program used by a content playback device that controls playback of content having embedded therein a plurality of watermark information pieces, each type of watermark information piece corresponding with each of a plurality of predetermined playback restrictions, the content playback program including the steps of: detecting a watermark information piece in the content; storing a history of detection results for a type of watermark information; executing a playback restriction corresponding to a type of watermark information piece for which a stored history of detection results satisfies a predetermined condition; comparing, in a case that a watermark information piece has been detected, an extent of the playback restriction corresponding to a type of the currently detected watermark information piece to an extent of the playback restriction corresponding to the type of watermark information piece for which the history of detection results has been stored, and judging, based on a result of the comparison, whether or not a detection result for the currently detected watermark information piece is to be stored in the storage unit; and when the judgment unit judges affirmatively, storing the detection result for the currently detected watermark information piece in the storage unit.

The integrated circuit is an integrated circuit that controls playback of content having embedded therein a plurality of watermark information pieces, each type of watermark information piece corresponding with each of a plurality of predetermined playback restrictions, the integrated circuit including: a detection unit operable to detect a watermark information piece in the content; a storage unit operable to store therein a history of detection results for a type of watermark information; a control unit operable to execute a playback restriction corresponding to a type of watermark information piece for which a stored history of detection results satisfies a predetermined condition; a judgment unit operable to, in a case that a watermark information piece has been detected, compare an extent of the playback restriction corresponding to a type of the currently detected watermark information piece to an extent of the playback restriction corresponding to the type of watermark information piece for which the history of detection results has been stored, and to judge, based on a result of the comparison, whether or not a detection result for the currently detected watermark information piece is to be stored in the storage unit; and an update unit operable to, when the judgment unit judges affirmatively, store the detection result for the currently detected watermark information piece in the storage unit.

According to this structure, when watermark information is detected that corresponds to a different playback restriction from the current playback restriction during playback control of the content, a detection result can be selected for watermark information pertaining to a more appropriate extent of playback restriction by comparing the extent of the playback restriction pertaining to the detected watermark information piece to the extent of the current playback restriction. Accordingly, playback control of the content can be performed appropriately.

Another aspect of the present invention is a content playback device that controls playback of content having embedded therein a plurality of watermark information pieces, each type of watermark information piece corresponding with each of a plurality of predetermined playback restrictions, the content playback device including a detection unit operable to detect a watermark information piece in the content; a storage unit operable to store therein one or more digital watermark information pieces and a history of detection results for each of the one or more watermark information pieces; an update unit operable to, when a digital watermark is detected, additionally store the judgment result for the currently detected digital watermark in the storage unit; and a control unit operable to execute a playback restriction corresponding to a stored watermark information piece for which a stored history of detection results satisfies a predetermined condition.

According to this structure, detection results can be stored for a plurality of digital watermarks, and playback restrictions can be executed in accordance with the detection results. Accordingly, an appropriate playback restriction can be executed even when a plurality of digital watermarks have been detected in the content.

The storage unit may store the detection results so that detection results pertaining to each of the plurality of digital watermarks can be distinguished from each other. When a detection result history pertaining to one of a plurality of digital watermarks stored in the storage unit satisfies a predetermined condition, the control unit may execute the playback restriction corresponding to the digital watermark for which the detection result history satisfies the predetermined condition.

This structure enables judging in parallel, for a plurality of digital watermark detection result histories, whether the condition for executing the playback restriction has been satisfied, and executing the playback restriction pertaining to any detection result histories that have satisfied the condition. This structure enables appropriately executing a playback restriction corresponding to detected digital watermarks when a plurality of digital watermarks are stored together in the content, and different digital watermarks are detected in alternation.

The storage unit may store the detection results so that detection results pertaining to each of the plurality of digital watermarks can be distinguished from each other. Furthermore, when the predetermined condition is satisfied simultaneously by detection results for a plurality of watermark types, the control unit may simultaneously execute the playback restrictions corresponding to each of the watermark types for which the detection results have satisfied the predetermined condition.

According to this structure, when detection results for a plurality of watermark types simultaneously satisfy the condition for executing a playback restriction, a plurality of playback restrictions are executed at the same time. Accordingly, playback restrictions to be executed are executed without omission, even when the detection results for a plurality of watermark types simultaneously satisfy the condition.

The storage unit may store the detection results so that detection results pertaining to each of the plurality of digital watermarks can be distinguished from each other. Furthermore, when the predetermined condition is satisfied simultaneously by the detection results for a plurality of watermark types, the control unit may execute the playback restriction having the strictest extent from among the playback restrictions corresponding to each of the watermark types for which the detection results have satisfied the predetermined condition.

According to this structure, when the detection results for a plurality of watermark types simultaneously satisfy the predetermined condition, the playback restriction having the strictest extent is executed. Accordingly, when the detection results for a plurality of watermark types have simultaneously satisfied the predetermined condition, this structure prevents a decrease in safety that would occur if only a playback restriction having a less strict extent is executed.

Embodiments of the present invention are described below with reference to the drawings.

### 1. Embodiment 1

### 1.1 Structure

1.1.1. Digital Watermark Embedding/Detection System Structure

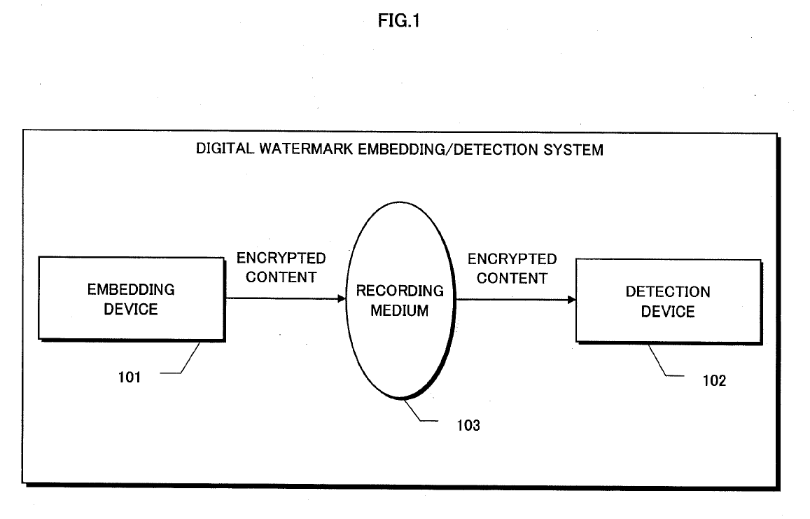

As shown in FIG. 1, the digital watermark embedding/detection system includes an embedding device 101, a detection device 102, and a recording medium 103.

The embedding device 101 embeds watermark information in content, encrypts the content, and records the content to the recording medium 103.

An audio portion of the content is divided into blocks, which are units for digital watermark detection, and the watermark information is embedded in such blocks. However, not all of the blocks have watermark information embedded therein, and some blocks do not have watermark information embedded therein.

The detection device 102 reads the encrypted content from the recording medium 103, and decrypts the encrypted content.

The detection device 102 detects watermark information in the content obtained as a result of the decryption, and stores the detected watermark information and a detection frequency of the watermark information.

Here, the detection device 102 stores the detection frequency pertaining to only one type of watermark information. When the detected watermark information is different from the watermark information that has already been stored, a judgment is made, according to a predetermined condition, as to whether to replace the stored watermark information with the currently detected watermark information, and the watermark information is replaced only when the replacement is judged to be necessary.

Various conditions can be used as the predetermined condition, such as “replace if the playback restriction pertaining to the detected watermark information is stricter than the playback restriction pertaining to the stored watermark information”.

The detection device 102 performs content playback control based on stored watermark information pieces and detection frequencies.

Accordingly, even if a plurality of types of watermark information have been detected, the detection device 102 can appropriately perform playback control of the content in accordance with one stored watermark information piece that satisfies the predetermined condition, and the detection frequency corresponding to the watermark information piece.

The playback control is performed in accordance with an internally stored operation control table, which is a list correlating watermark information pieces to operations to be performed by a device that detects the respective watermark information piece.

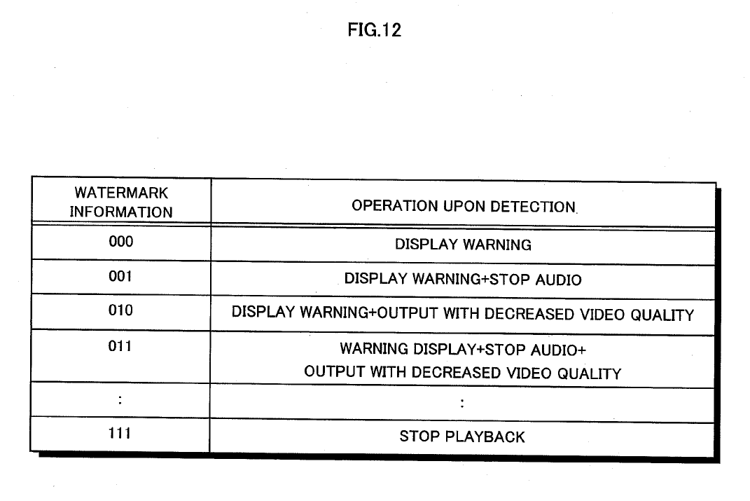

FIG. 12 shows an example of the operation control table.

For example, if the detection device 102 detects a watermark information piece “000” in the content, the operation corresponding to the watermark information piece “000” in the operation control table is performed. Specifically, a warning message is displayed indicating that the content is unauthorized.

Also, if a watermark information piece “111” is detected, the detection device 102 performs the operation corresponding to the watermark information piece “111” in the operation control table. Specifically, playback of the content is stopped.

Similarly, when another type of watermark information is detected, the detection device 102 performs the operation corresponding to the type of detected watermark information, according to the operation control table.

The operation control table includes a plurality of operations to be performed when watermark information is detected. In the operation control table of the present embodiment, the operation listed in the top row has an extent that is least strict, and the stricter the playback restriction corresponding to an operation is, the farther down the operation appears in the operation control table.

Specifically, the operation “display warning” which corresponds to the watermark information piece “000” listed in the top row is the playback restriction whose extent is least strict, and the operation “display warning+stop audio” corresponding to a watermark information piece “001” listed on the row below is the playback restriction that has a second least strict extent. The operation “stop playback” corresponding to the watermark information piece “111” listed on the bottom row is the playback restriction whose extent is strictest.

Note that the provider of the operation control table may determine the extent of the playback restrictions by manually determining the arrangement of data in the control table. Alternatively, if the detection device 102 has received an arbitrarily ordered operation control table, the detection device 102 may judge the strictness of the extent of the playback restrictions according to how many playback functions are restricted, and rearrange the data according to the judgment. Also, the criteria for the extent of strictness may be changed as appropriate based on whether more important data is included in the video or the audio portion of the content. For example, in the case of the operation “display warning+stop audio” corresponding to the watermark information piece “001”, and the operation “display warning+output with decreased video quality” corresponding to a watermark information piece “010”, the content can be protected appropriately by judging that the extent is stricter in the former case if the audio content is more important, and in the latter case if the video content is more important.

In the present embodiment, the detection device 102 does not perform an operation immediately upon detecting one watermark information piece in one block, but rather performs one or more of the operations listed in the operation control table if a plurality of watermark information pieces detected successively in a plurality of blocks satisfy a predetermined condition.

Specifically, the detection device 102 attempts to detect watermark information pieces in five consecutive blocks (each block is the above-described unit for digital watermark detection). If watermark information pieces are detected in two or more blocks, the condition is satisfied, and the operation listed in the operation control table is executed.

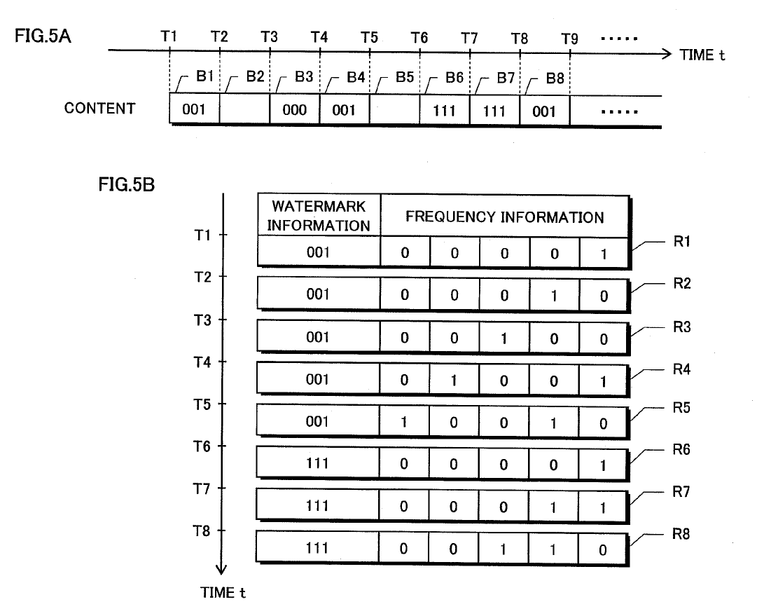

FIGS. 5A and 5B conceptually illustrate playback control of content according to the types of detected watermark information and the detection frequency of each type.

FIG. 5A shows a content that includes blocks B1 to B8, and illustrates that block B1 is played back at time T1, and block B2 is played back at time T2.

The number “001” in B1 indicates that the watermark information piece “001” has been embedded in block B1. Similarly, the number 000 in B3 indicates that the watermark information piece “000” has been embedded in B3.

When blocks B1 to B8 of the content are played back, the detection device 102 detects the watermark information piece “001” from B1 first from time T1 to T2.

At this time, since the condition “detecting watermark information pieces in two or more blocks from among five proximal blocks” has not been satisfied, the operation of displaying the warning message is not executed, and playback of B2 starts.

Then, from time T2 to T3, the detection device 102 plays back B2.

From time T3 to T4, the detection device 102 detects a second watermark information piece “000” in B3. However, since the playback restriction pertaining to 000 is not as strict as the playback restriction pertaining to 001 according to the operation control table in FIG. 12, the detection device 102 ignores the watermark information piece “000”.

For the times T4 to T5, the detection device 102 detects the watermark information piece “001”, in B4.

At this time, since the condition “detecting watermark information pieces in two or more blocks from among five proximal blocks” has been satisfied upon detecting 001, the detection unit 102 displays the warning message and stops audio output according to 001 in the operation control table.

Although a watermark information piece is not detected in B5 for the times T5 to T6, since the condition “detecting watermark information pieces in two or more blocks from among five proximal blocks (here, B1 to B5)” is satisfied, the detection device 102 continues displaying the warning message.

For times T6 to T7, the detection device 102 detects 111 in B6, and since the playback restriction pertaining to 111 is stricter than the playback restriction pertaining to 001 according to the operation control table in FIG. 12, the detection device 102 changes a watermark information piece to be stored from 001 to 111.

At this time (time T7), the detection device 102 stops operation of the playback restriction pertaining to 001, and starts normal playback of B7.

For times T7 to T8, the detection device 102 detects 111 in B7. Thus, the condition “detecting watermark information pieces in two or more blocks from among five proximal blocks (here, B3 to B7)” is satisfied. Accordingly, the detection device 102 performs the operation of the playback restriction corresponding to the watermark information piece “111”. Specifically, the detection device 102 stops both audio and video output of the content.

For times T8 to T9, although a watermark information piece was not detected in B8, the condition “detecting watermark information pieces in two or more blocks from among five proximal blocks (here, B4 to B8)” is still satisfied. Accordingly, the detection device 102 continues to stop output of the content.

1.1.2 Embedding Device 101 Structure

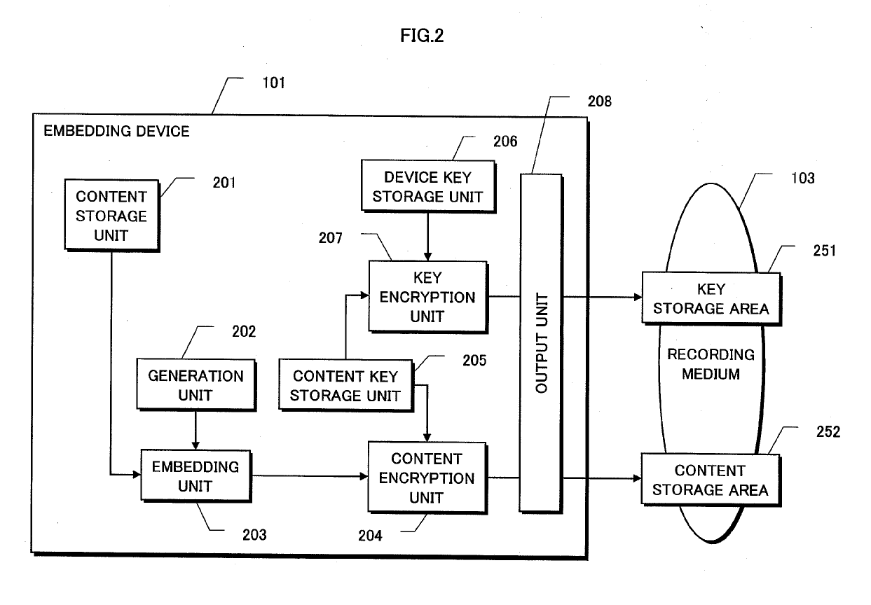

As shown in FIG. 2, the embedding device 101 includes a content storage unit 201, a generation unit 202, an embedding unit 203, a content encryption unit 204, a content key storage unit 205, a device key storage unit 206, a key encryption unit 207, and an output unit 208.

The embedding device 101 specifically includes a microprocessor, a RAM, a ROM, a hard disk, etc. that are not depicted. Computer programs are stored on the RAM, the ROM and the hard disk, and the functions of the embedding device 101 are fulfilled by the microprocessor operating in accordance with the programs.

Note that the various function blocks of the content storage unit 201, the generation unit 202, the embedding unit 203, the content encryption unit 204, the content key storage unit 205, the device key storage unit 206, the key encryption device 207, the output unit 208, etc. are realized by an LSI.

The following describes each of the elements.

The content storage unit 201 stores content in which to embed watermark information pieces.

The content storage unit 201 is specifically realized by a nonvolatile memory, a hard disk, or the like.

The generation unit 202 generates watermark information pieces for embedding in the content, and supplies the watermark information pieces to the embedding unit 203.

The embedding unit 203 divides the audio portion of the content stored in the content storage unit 201 into blocks that are the units for digital watermark detection, and embeds the watermark information pieces generated by the generation unit 202 in the blocks.

After the watermark information pieces have been embedded, the content becomes, for example, the content already described with use of FIG. 5A.

The content key storage unit 205 stores a content key that is a key for encrypting the content.

With use of the content key stored in the content key storage unit 205, the content encryption unit 204 encrypts content constituted from an audio portion in which a watermark has been embedded, and a video portion in which a watermark has not been embedded.

For example, DES encryption or AES encryption is used for encrypting the content. Since these encryption technologies are known technologies, description thereof is omitted.

The device key storage unit 206 stores a device key that is a key for encrypting the content key. Although typically each device key is correlated uniquely to one digital watermark detection device, one device key may be correlated to a plurality of digital watermark detection devices.

The key encryption unit 207 encrypts the content key with use of the device key.

For example, DES encryption, AES encryption, or the like is used for encrypting the content key.

The output unit 208 records the encrypted content generated by the content encryption unit 204 and the encrypted content key generated by the key encryption unit 207 in a content storage area 252 and a key storage area 251 of the recording medium 103, respectively.

1.1.3 Detection Device 102 Structure

1.1.3.1 Overall Structure

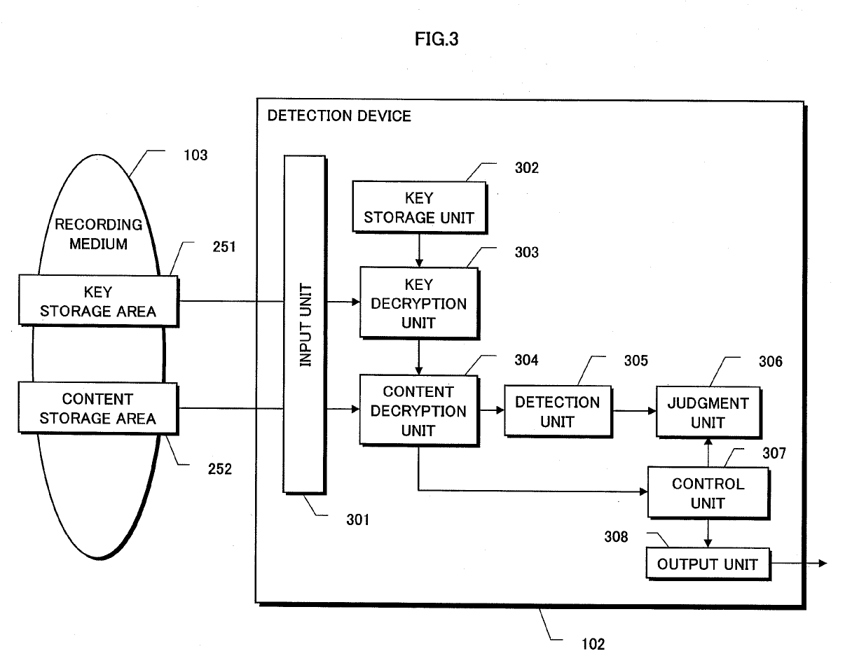

As shown in FIG. 3, the detection device 102 includes an input unit 301, a key storage unit 302, a key decryption unit 303, a content decryption unit 304, a detection unit 305, a judgment unit 306, a control unit 307 and an output unit 308.

The detection unit 102 specifically includes a microprocessor, a RAM, a ROM, a hard disk, etc. that are not depicted. Computer programs are stored on the RAM, the ROM and the hard disk, and the functions of the detection unit 102 are fulfilled by the microprocessor operating in accordance with the programs.

Note that each of the function blocks of the input unit 301, the key storage unit 302, the key decryption unit 303, the content decryption unit 304, the detection unit 305, the judgment unit 306, the control unit 307 and the output unit 308 are realized by an LSI that is an integrated circuit.

The following describes each of the elements.

The input unit 301 reads the encrypted content key and the encrypted content from the key storage area 251 and the content storage area 252 of the recording medium 103, respectively.

The key storage unit 302 stores the device key for decrypting the encrypted content key.

Although the device key is preferably unique to each detection device 102, the device key may be shared between a plurality of detection devices.

With use of the device key stored in the key storage unit 302, the key decryption unit 303 decrypts the encrypted content key read from the recording medium 103.

With use of the content key decrypted by the key decryption unit 303, the content decryption unit 304 decrypts the encrypted content read from the recording medium 103.

First, the detection unit 305 divides the audio portion of the content decrypted by the content decryption unit 304 into blocks that are the units for digital watermark detection. Next, the detection unit 305 detects embedded watermark information in the blocks generated as a result of the division. Then, the detection unit 305 notifies the detected watermark information to the judgment unit 306.

The judgment unit 306 judges whether playback of the content is permitted based on the watermark information detected by the detection unit 305. The judgment unit 306 is described in detail later.

The control unit 307 controls playback of the content based on a judgment result of the judgment unit 306. The details are described later.

According to the control performed by the control unit 307, the output unit 308 receives content to be played back, and outputs the received content to a display device such as a display monitor.

1.1.3.2 Judgment Unit 306 and Control Unit 307 Structures

First, the structure of the judgment unit 306 is described.

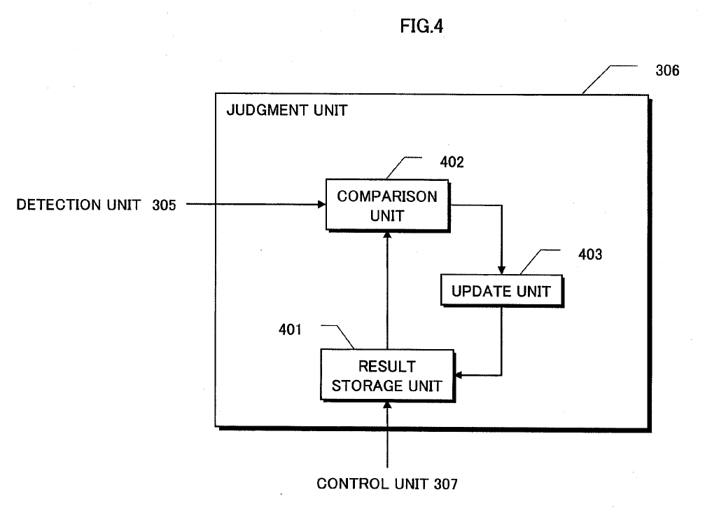

As shown in FIG. 4, the judgment unit 306 includes a result storage subunit 401, a comparison subunit 402, and an update subunit 403, and these units are realized as an LSI.

(1) Result Storage Subunit 401

The result storage subunit 401 stores result information including watermark information detected by the detection device 102 and frequency information indicating a frequency at which a watermark information piece appears.

FIG. 5B shows exemplary result information.

Result information pieces R1 to R8 indicate result information at times T1 to T8 when the content shown in FIG. 5A is played back. For example, R1 is result information at the time T2, and R2 is result information at the time T3.

The result information includes watermark information and frequency information.

The frequency information is formed as a 5-digit bit string. Each digit corresponds to a block in the content, and indicates a history of whether watermark information has been detected in that block.

For each digit, “0” indicates that watermark information has not been detected, and “1” indicates that watermark information has been detected. For convenience, among the five-digit bit rows, the first digit on the left is referred to as the first digit, and the last digit on the right is referred to as the last digit.

As the playback of the content proceeds, whenever the playback advances to a next block targeted for playback, the frequency information shifts one place to the left, as in a shift register.

When the information of the first digit is discarded as a result of the shift, a detection result for a new block is stored as the last digit.

Specifically, the result of the immediately previous watermark information detection processing is reflected in the last digit of the frequency information, and the result of the detection processing from four times before the immediately previous detection is reflected in the first digit. In all, detection processing results from the previous five detections are held.

In the example of the detection information piece R5, the first digit is “1”, indicating that “001” has been detected in the block B1 that is targeted for playback from time T1 to T2.

The second and third digits after the first digit are “0”, indicating that “001” has not been detected in the blocks B2 and B3 targeted for playback from time T2 to T3 and T3 to T4.

The fourth digit is “1”, indicating that “001” has been detected in block B4 that is targeted for playback from time T4 to T5.

The last digit is “0”, indicating that “001” has not been detected in block B5 that is targeted for playback from time T5 to T6.

Note that although here, the appearance frequencies, etc. of the digital watermarks are stored in the form of a table such as the table shown in FIG. 5, the present invention is not limited to this, and another type of data structure may be used for managing the appearance frequencies.

(2) Comparison Subunit 402

The comparison subunit 402 compares the watermark information detected by the detection unit 305 to the watermark information in the result information stored in the result storage subunit 402, and by referencing a predetermined condition, determines whether updating the result information is necessary.

In the present embodiment, for example, the predetermined update condition is satisfied if “the extent of the playback restriction according to the detected watermark information is stricter than the extent of playback restriction according to the watermark information in the result information.” According to this condition, when the detection unit 305 has detected watermark information whose playback restriction is stricter than the watermark information in the result information, the comparison subunit 402 instructs the update subunit 403 to update the watermark information in the result information, and to change (hereinafter referred to as “reset”) all of the data pieces for each digit of the frequency information to zero.

On the other hand, when the watermark information piece detected by the detection unit 305 is the same as the watermark information piece in the result information, the comparison subunit 402 instructs the update subunit 403 to update the frequency information in the result information.

As described above, this update is performed by shifting each piece of the data in the frequency information one place to the left, and storing the data “1” in the last place on the right.

Also, if watermark information is not detected by the detection unit 305, the comparison subunit 402 instructs the 5) update subunit 403 to update the frequency information.

For example, this update is performed by shifting the data of the frequency information one place to the left, and storing the data “0” in the last place on the right.

(3) Update Subunit 403

Based on the result of the comparison by the comparison subunit 402 and the instruction from the comparison subunit 402, the update subunit 403 updates the watermark information and the frequency information in the result information stored in the result storage subunit 401.

The following describes the control unit 307.

The control unit 307 controls playback of the content based on the judgment result of the judgment unit 306.

Each time that processing is performed on a block that is a measurement unit for detection, the control unit 307 references the watermark information and the frequency information in the result information stored in the result storage subunit 401, and if the frequency information satisfies the predetermined condition, the control unit 307 executes the operation corresponding to the watermark information.

### 1.2 Operation

The following sequentially describes digital watermark embedding processing and digital watermark detection processing performed by the embedding device 101 and the detection device 102 that have the structures described above.

1.2.1 Digital Watermark Embedding Processing

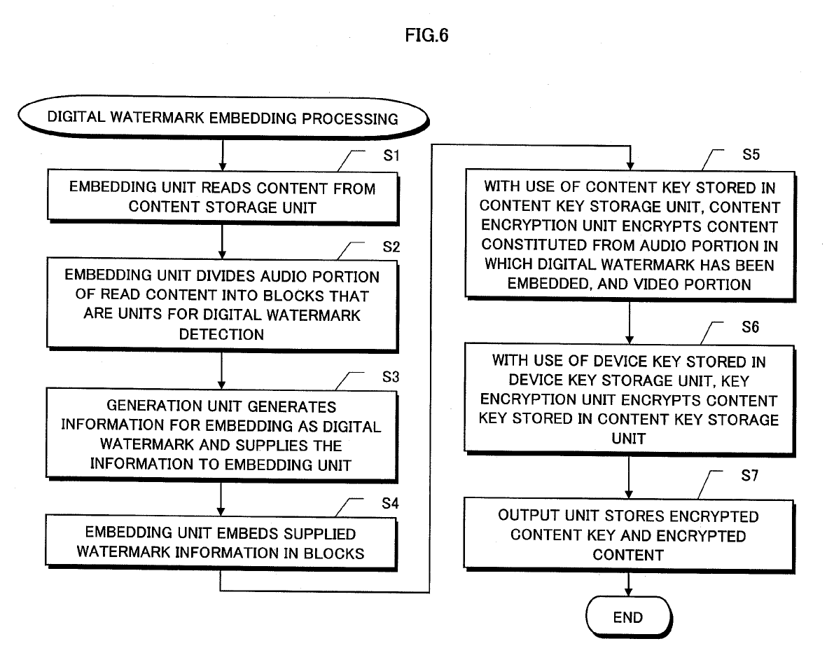

Digital watermark embedding processing performed by the embedding device 101 is described with reference to FIG. 6.

First, the embedding unit 203 reads, from the content storage unit 201, the content in which to embed the digital watermark (step S1), and divides the audio portion of the read content into the blocks that are units for digital watermark detection (step S2).

Next, the generation unit 202 generates the watermark information for embedding as the digital watermark, and supplies the watermark information to the embedding unit 203 (step S3).

For each of the blocks generated as a result of the division, the embedding unit 203 embeds a piece of the supplied watermark information (step S4).

Next, with use of the content key stored in the content key storage unit 205, the content encryption unit 204 encrypts the content constituted from the audio portion in which the digital watermark has been embedded, and the video portion in which the digital watermark has not been embedded (step S5).

Next, with use of the device key stored in the device key storage unit 206, the key encryption unit 207 encrypts the content key stored in the content key storage unit 205 (step S6).

Then, the output unit 208 stores the encrypted content key encrypted by the key encryption unit 207, and the encrypted content encrypted by the content encryption unit 204 to the recording medium 103 (step S7).

1.2.2 Digital Watermark Detection Processing

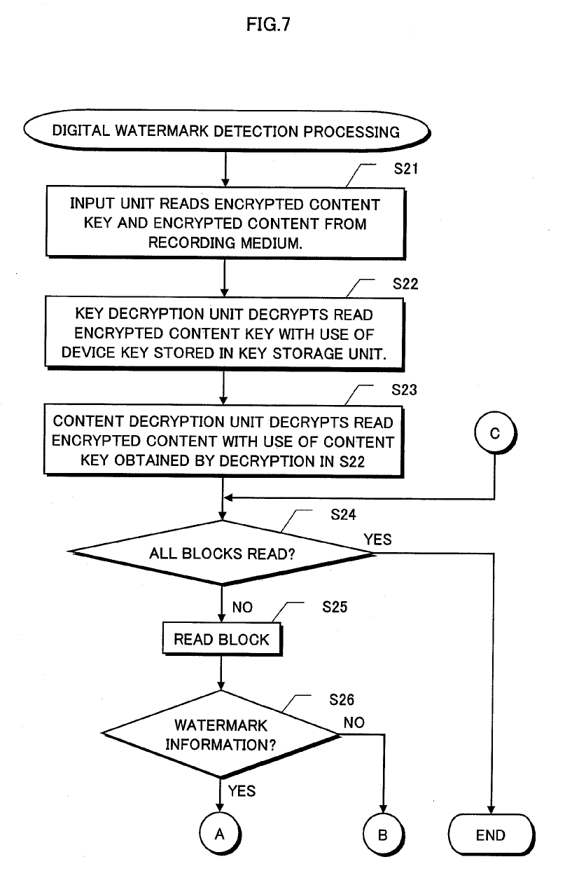

The following describes digital watermark detection processing performed by the detection device 102 with reference to FIG. 7.

First, the input unit 301 of the detection device 102 reads the encrypted content key and the encrypted content from the recording medium 103 (step S21).

Next, with use of the device key stored in the key storage unit 302, the key decryption unit 303 decrypts the read encrypted content key (step S22).

Then, the content decryption unit 304 decrypts the read encrypted content with use of the content key obtained by the decryption in step S22 (step S23).

Next, the detection unit 305 judges whether all of the blocks included in the content obtained as a result of the decryption in step S23 have been read (step S24).

If all of the blocks have been read (step S24: YES), processing ends.

If all of the blocks have not been read (step S24: NO), the unread blocks are read (step S25), and the detection device judges whether watermark information has been embedded in the read blocks (step S26).

If watermark information has not been embedded (step S26: NO), processing proceeds to the later-described step S31.

If watermark information has been embedded (step S26: YES), the comparison subunit 402 judges whether the detected watermark information is the same as the watermark information in the result information (step S27).

If the detected watermark information is the same as the watermark information in the result information (step S27: YES), processing proceeds to the later-described step S31.

If the detected watermark information is different from the watermark information in the result information (step S27: NO), a judgment is made, with reference to the operation restriction table, as to whether the extent of playback restriction according to the detected watermark information is stricter than the extent of playback restriction according to the watermark information in the result information (step S28).

If the extent of the playback restriction according to the detected watermark information is not stricter than the extent of the playback restriction according to the watermark information in the result information (step S28: NO), processing proceeds to the later-described step S31.

If the extent of the playback restriction according to the detected watermark information is stricter than the playback restriction according to the watermark information in the result information (step S28: YES), the comparison subunit 402 instructs the update subunit 403 to update the result information (step S29).

Based on the update instruction from the comparison subunit 402, the update subunit 403 replaces the watermark information in the result information with the detected watermark information, and resets all digits of the frequency information to 0 (step S30).

The update subunit 403 updates the frequency information in the result information (step S31).

Next, the control unit 307 references the frequency information in the result information, and judges whether the predetermined condition for restricting playback has been satisfied (step S32). Note that the condition in the present embodiment is, as described above, “detecting watermark information pieces in two or more blocks from among five proximal blocks”. In the present embodiment, frequency information is stored as 0 or 1 to indicate whether watermark information is included in the five previous blocks. Accordingly, the condition is satisfied when two or more “1”s are included in the frequency information.

If the condition is satisfied, that is, if two or more “1”s are included in the frequency information (step S32: YES), a judgment is made regarding whether the playback restriction corresponding to the watermark information piece is being performed (step S33), and if the playback restriction is being performed (step S33: YES), processing proceeds to the later-described step S35.

If the playback restriction corresponding to the watermark information piece is not being performed (step S33: NO), the control unit 307 executes the playback restriction corresponding to the watermark information piece (step S34). Also, if the playback restriction is already being performed (step S33: YES), that playback restriction continues to be performed.

In step S32, if the condition is not satisfied, specifically if a judgment is made that the frequency information does not include two or more “1”s (step S32: NO), a judgment is made as to whether the playback restriction is being performed (step S36), and if the playback restriction is being performed (step S36: YES), the playback restriction is cancelled, normal playback is performed (step S37), and processing proceeds to step S35.

If a judgment is made in step S36 that the playback restriction is not being performed (step S36: NO), processing proceeds to step S35.

In step S35, the output unit 308 outputs the content to a display device such as a display monitor according to the control of the control unit 307 in step S34 (step S28).

### Embodiment 2

In embodiment 1, only result information for one type of watermark information is stored in the result storage subunit 401 at a time.

In the present embodiment, if a plurality of types of watermark information are detected in the content, the detection device stores result information for all of the detected types of watermark information, judges whether to execute all of the restriction operations based on the detected types of watermark information, and performs playback control according to the judgment result.

The following describes the digital watermark embedding/detection system pertaining to embodiment 2.

Note that since the structure of the digital watermark embedding/detection system, the structure of the digital watermark embedding device, the operation of the digital watermark embedding device, and the operation of the digital watermark detection device are the same as in embodiment 1, description thereof is omitted here.

### 2.1 Detection Device 102 Structure

In the present embodiment, the structure and operation of the judgment unit 306 and the control unit 307 in the detection device 102 are different from embodiment 1.

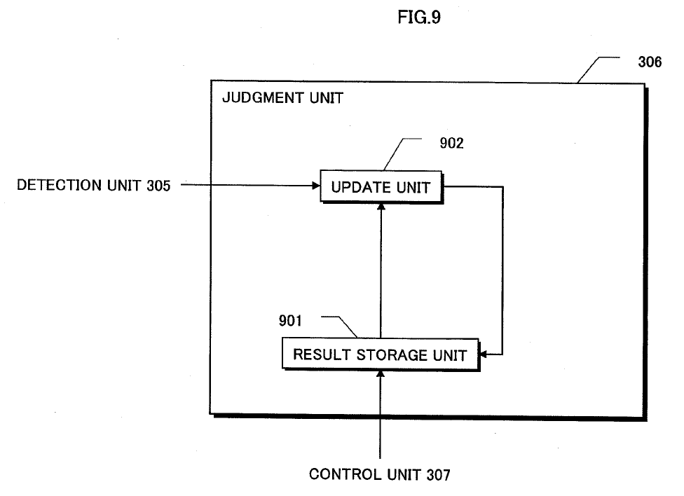

As shown in FIG. 9, the judgment unit 306 in the present embodiment includes a result storage subunit 901 and an update subunit 902.

(1) Result Storage Subunit 901

For each of the plurality of types of watermark information detected by the detection device 102, the result storage subunit 901 stores result information constituted from the watermark information and frequency information indicating the frequency of appearance of the type of watermark information.

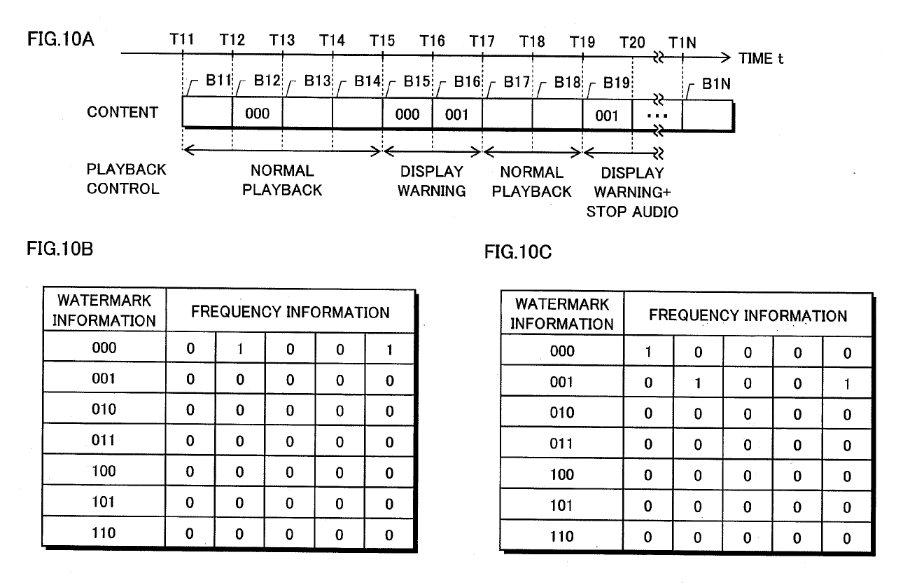

FIG. 10A shows a content that includes blocks B11 to B19.

FIG. 10B shows result information at the time T16 which includes detection results for each of the watermark information pieces 000 to 110 in B11 to B15 corresponding to times T11 to T16. The frequency information is the same as described in embodiment 1.

FIG. 10C is result information at the time T20 which includes detection results for each of the watermark information pieces in B15 to B19 corresponding to times T15 to T20.

Note that as described later, the detection device 102 of the present embodiment adds result information each time that new watermark information is detected. For that reason, the tables shown in FIGS. 10B and 10C also include result information for the watermark information pieces “010” and so on, which are not depicted in FIG. 10A. These watermark information pieces are either watermark information pieces detected in blocks that are not depicted in FIG. 10A, or watermark information pieces detected previously in another piece of content.

Note that if the types of watermark information that can be detected are known in advance from supplementary information or the like supplied along with the content, “0”s may be stored as result information in the table in advance, for all digits of the frequency information, for all such watermark information types.

(2) Update Subunit 902

The update subunit 902 compares the watermark information detected by the detection unit 305 to each of the watermark information pieces in the result information, and determines whether the result information needs to be updated.

If the detection unit 305 detects watermark information pieces that are different from all of the watermark information pieces in the result information, the update subunit 902 adds the detected watermark information to the result information, and updates all of the frequency information of the watermark information.

Specifically, if the detection unit 305 detects watermark information that is different from the watermark information in the result information, result information indicating “1” as the last digit and “0” as the other digits is added to the frequency information pertaining to that watermark information.

If the detection unit 305 detects watermark information that matches at least one watermark information piece stored in the result storage subunit 901, all digits of the frequency information are shifted one place to the left, and “1” is set as the last digit for the detected watermark information.

In either case, all digits of the data are shifted one place to the left and “0” is set as the last digit for frequency information in the result information of the watermark information that is different from the watermark information detected by the detection unit 305.

Also, if watermark information is not detected in a block by the detection unit 305, the update subunit 902 shifts each digit of the data of the frequency information in the result information one place to the left, and updates the last digit to “0”.

(3) Control Unit 307

Each time the result information is updated, for each frequency information piece in the result information, the control unit 307 judges whether the predetermined condition is satisfied, and if the predetermined condition is satisfied, performs the playback restriction corresponding to the frequency information that satisfies the condition, in accordance with the operation control table. Playback restriction processing is the same as in embodiment 1.

Note that in the present embodiment, if a plurality of frequency information pieces satisfy the condition at the same time, the strictest playback restriction is performed. However, the present invention is not limited to this, and the least strict playback restriction may be performed, or if possible, a plurality of playback restrictions may be performed in parallel.

### 3. Other Variations

Although described based on the above embodiments, the present invention is of course not limited to such embodiments. Variations such as the following are also included in the present invention.

(1) Although only one result information piece is stored for each watermark information piece in embodiment 1, the present information is not limited to this.

For example, two or more result information pieces may be stored.

In such a case, for example if three result information pieces are stored, and a fourth watermark information piece is detected, the watermark information piece to be stored may be changed according to a predetermined condition.

For example, the oldest detected watermark information 25, piece may be replaced with a new detected watermark information piece. Also, a watermark information piece having a lowest priority may be replaced, or a watermark information piece whose appearance frequency is least (having a fewest number of appearance frequency “1”s) may be replaced.

Also, even when frequency information pieces for a plurality of watermark information pieces are stored, if a watermark information piece is detected that is different from the stored watermark information pieces, the frequency information pieces pertaining to the watermark information pieces other than the detected watermark information piece may be reset.

(2) Although in embodiment 1, only one watermark information piece is stored, the present invention is not limited to this. One or more watermark information pieces that satisfy a predetermined condition may be stored, and a judgment may be made as to whether to execute the determined operation.

For example, the predetermined condition may be a condition based on the order in which the watermarks were detected, a condition based on a preset priority, or a condition based on strictness of the operation to be performed when the watermark is detected.

For example, when using a condition based on the order in which the watermarks were detected, the watermark information detected earliest may be preferentially stored and new detected watermark information be ignored, or in the opposite way, the newest detected watermark information may be preferentially stored.

The former example is effective when it is desirable to give a higher priority to an operation pertaining to watermark information that corresponds to a portion closer to the beginning of the content being played back, and the latter example is effective when it is desirable to give a higher priority to an operation pertaining to watermark information that corresponds to a portion closer to the end of the content.

As an example of a condition based on strictness of the operation to be performed when the watermark is detected, either watermark information corresponding to an operation having a stricter restriction may be stored, or watermark information corresponding to an operation having a less strict restriction may be stored.

Storing the watermark information corresponding to the least strict operation is useful for suppressing disadvantages to a user as much as possible, for example when a birthday party is recorded on a camcorder and watermark information of an animated movie is inadvertently recorded.

Also, storing watermark information corresponding to the strictest restriction is useful for excluding pirated copies that store a plurality of movies as content.

(3) Although in embodiment 1, watermark information and frequency information stored as result information in the result storage unit are updated, the present invention is not limited to this. For example, the detection device may continue to store any already-stored watermark information pieces and frequency information pieces even after receiving a new watermark information piece to be updated, and the new received watermark information piece may be stored additionally.

(4) In embodiment 1, an example is described in the description of the comparison subunit 402 of the predetermined update condition being satisfied if “the extent of the playback restriction according to the detected watermark information is stricter than the extent of playback restriction according to the watermark information in the result information”. However, the present invention is not limited to this.

For example, the predetermined update condition may be “holding an information piece whose priority is higher”. The following describes the operation of the comparison subunit 402 if the predetermined update condition is “holding an information piece whose priority is higher”.

Upon the detection unit 305 detecting a different type of watermark information from the watermark information in the result information, the comparison subunit 402 compares a priority of the watermark information detected by the detection unit 305 to a priority of the watermark information in the result information.

Although the “priorities” referred to here are not depicted in FIG. 12, a priority has been determined in advance for each watermark information piece.

If a priority of the type of watermark information piece received from the detection unit 305 is higher than or equal to a priority of watermark information piece in the result information, the comparison subunit 402 instructs the update subunit 403 to update the watermark information in the result information and to reset the frequency information.

On the other hand, if the priority of the watermark information piece received from the detection unit 305 is lower than the priority of the watermark information piece in the result information, the comparison subunit 402 instructs the update subunit 403 to shift each digit of the data in the frequency information one place to the left, and to store the data “0” as the last digit.

Also, if watermark information is not detected by the detection unit 305, the comparison subunit 402 instructs the update subunit 403 to shift each digit of the data in the frequency information one place to the left, and to store the data “0” as the last digit.

On the other hand, if the detection unit 305 detects watermark information that is the same as the watermark information in the result information, the comparison subunit 402 instructs the update subunit 403 to update the frequency information in the result information. This update is performed by shifting each digit of the data in the frequency information one place to the left, and storing the data “1” on the right end.

In the above example, if a watermark is detected that has a same priority as the watermark information in the result information and that is a different type of watermark information, the update subunit 403 is instructed to update the watermark information and reset the frequency information. However, the present invention is not limited to this. Similarly to when a watermark information piece having a low priority is detected, the comparison subunit 402 may instruct the update subunit 403 to shift each digit of the data in the frequency information one place to the left, and to store the data “0” as the last digit.

Furthermore, as another example, the predetermined update condition may be “always hold the newest watermark information”. The following describes the operation of the comparison subunit 402 if the predetermined update condition is “always hold the newest watermark information”.

If the detection unit 305 detects watermark information of a different type from the watermark information in the result information, the comparison subunit 402 instructs the update subunit 403 to update the watermark information in the result information and reset the frequency information.

On the other hand, if the detection unit detects watermark information of the same type as the watermark information in the result information, the comparison subunit 402 instructs the update subunit 403 to update the frequency information in the result information. This update is performed by shifting shift each digit of the data in the frequency information one place to the left, and to store the data “1” in the last place on the right.

(5) Although in embodiment 2, the result storage unit stores result information for all detected watermark information pieces, the present invention is not limited to this structure.

For example, a threshold may be set in advance, and only a threshold number of result information pieces may be stored.

Specifically, if 3 has been set as the threshold, only 3 pieces of result information are stored.

In such a case, if a fourth watermark information piece is detected, operation such as in the above-described variation 1 may be performed for determining which watermark information piece to replace.

(6) Although in embodiment 2, the control unit references all of the watermark information pieces and frequency information pieces stored in the result storage unit to judge whether executing the predetermined playback restriction operation is necessary, the present invention is not limited to this structure.

For example, the control unit may reference only watermark information received at a certain time (or pertaining to a certain block) to judge whether executing the operation is necessary.

Also, if an operation pertaining to another watermark information piece is already being executed, the control unit may refer to the received watermark information and the corresponding frequency information, and judge whether to continue the operation pertaining to the other watermark information piece.

Specifically, the control unit refers to the frequency information of the new received watermark information piece, judges whether executing the determined operation is necessary, and judges whether to continue the operation already being executed.

In such a case, referring to all of the stored watermark information pieces and frequency information pieces is not necessary.

Also, if a judgment is made that executing a plurality of operations is necessary, all of the operations may be executed, or only operations determined according to a predetermined rule may be executed.

Here, for example, the rule may be based on the order in which the watermarks were detected, on a preset priority, or on the strictness of the operation to be performed when the watermark is detected.

Specific examples of these rules may be similar to the conditions indicated in variation 2 for selecting a watermark information piece to be stored in embodiment 1.

(7) Although in embodiments 1 and 2, content is stored on a recording medium (an optical disk), the present invention is not limited to this structure.

For example, the content may be distributed via a network, or the content may be stored on a memory card or the like which is then distributed.

Also, the encrypted content key and the encrypted content need not be provided by the same distributor.

For example, the encrypted content key may be distributed via the network, and the encrypted content may be stored on an optical disk or the like which is then distributed.

(8) Although in embodiments 1 and 2, the embedding device and the detection device are each a single device, the present invention is not limited to this. For example, functions of the embedding device and the detecting device may be realized by a plurality of devices.

(9) Although in embodiments 1 and 2, the content in which the watermarks are embedded is encrypted, the present invention is not limited to this structure.

For example, the content may be recorded or transmitted without performing encryption on the content.

Also, the encryption is not necessarily performed by encrypting a content key with a device key, and encrypting the content with the content key, and other methods of encryption may be used.

Furthermore, the layers of encryption may be increased by introducing a new key, or in the opposite way, the layers of encryption may be decreased by causing the content to be directly encrypted with the device key.

Also, encryption may be applied after changing the values of the keys based on another data piece.

(10) Although in embodiments 1 and 2, the control unit controls playback of the content according to watermark information stored in the result storage unit, the present invention is not limited to this structure.

For example, rather than controlling the playback of the content, the control unit may control the management thereof, i.e. the output, transmission, copy, or transfer of the content.

Also, the control unit may control another type of processing, such as performing verification on a signature that is attached to the content, in accordance with the watermark information stored in the result storage unit, and whether watermark information has been detected.

(11) Information specifically indicating a detection location may be added to the result information stored by the result storage unit in embodiments 1 and 2, along with the appearance frequency.

Also, the frequency information is not limited to verifying the detection state of watermark information for five blocks at a time, and may also be managed with a management table that stores an arbitrary number of blocks that is more or less than five.

Also, in embodiments 1 and 2, the condition for performing a playback restriction for all of the watermark information pieces is “detecting watermark information pieces in two or more blocks from among five proximal blocks”, different conditions may be set for each watermark information piece. More specifically, the condition may be made stricter according to the extent of strictness of the playback restriction. This enables performing control so that the less strict the playback restriction, the more readily the playback restriction is executed, and the stricter the playback restriction, the less readily the playback restriction is executed.

(12) The table for managing appearance frequencies stored by the result storage unit in embodiments 1 and 2 may be structured so that watermark information for which a stipulated operation is being executed can be distinguished from other watermark information. Three specific examples are listed below.
(a) Flagging a watermark information piece for which the operation is being executed.
(b) Moving the watermark information piece for which the operation is being executed to the top of a list.
(c) Copying the watermark information piece for which the operation is being executed to another area that is different from the area in which the list is stored.

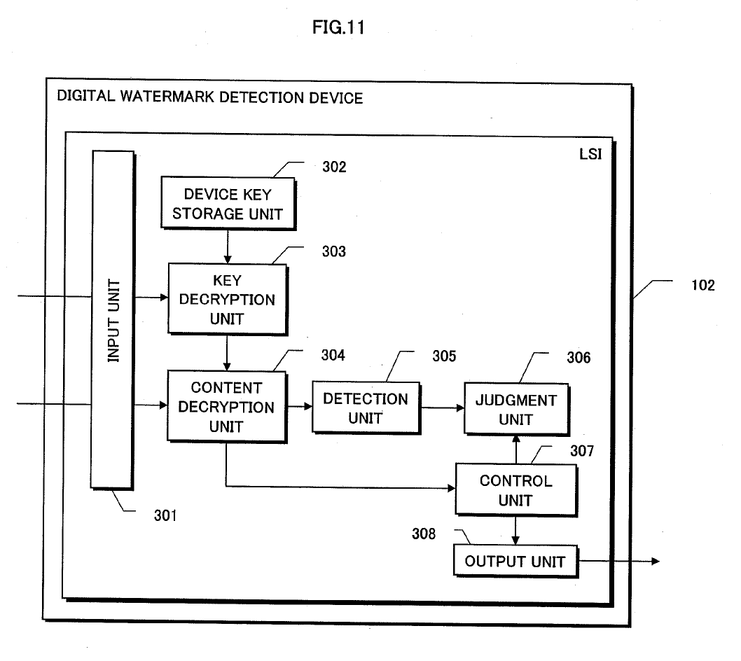

(13) In the above embodiments, function blocks such as the content storage unit 201, the generation unit 202, the embedding unit 203, the content encryption unit 204, the content key storage unit 205, the device key storage unit 206, the key encryption unit 207, and the output unit 208 are typically realized as LSI that are integrated circuits. The various function blocks may be realized as individual LSI chips as shown in FIG. 11 as an example, or may be partially or entirely realized as a single chip.

(14) In the above embodiments, an audio portion of the content is divided into blocks that are units for digital watermark detection, and watermark information corresponding to a desired operation is embedded in the blocks obtained by the division. However, the present invention is not limited to this, and the digital watermarks may be embedded in the video portion instead of the audio portion, for example.

(15) In embodiment 2, all of the detected watermark information is recorded. However, the present invention is not limited to this. For example, the present invention also includes a structure of not saving result information of new detected watermark information in a case that an extent of a playback restriction pertaining to the new detected watermark information is less strict than a playback restriction pertaining to watermark information that is already stored. Also, only watermark information corresponding to a playback restriction that is less strict than a predetermined extent may be stored, or only watermark information corresponding to a playback restriction that is stricter than a predetermined extent may be stored. This type of control is effective for causing the playback device to ignore a playback control, for example, when a playback restriction is specified that is not strict enough to cause more than a slight change in the quality of the content before and after execution of the playback control, or to ignore a playback control that cannot be executed, when there is a performance limit on the extent of playback restriction that can be executed in the detection device.

(16) The devices of the above embodiments and variations may be computer systems structured specifically from a microprocessor, a ROM, a RAM, a hard disk unit, etc. A computer program is stored in the RAM or the hard disk unit. Here, instruction code which indicates commands to the computer is structured as a combination of multiple instruction codes in order for the computer program to achieve predetermined functions. The devices achieve their functions as the microprocessor operates in accordance with the computer program. In other words, the microprocessor reads each instruction included in the computer program individually, deciphers the read instruction, and operates in accordance with the deciphered instruction generated by deciphering the read instruction.

Note that the devices are not limited to being computer systems including all of a microprocessor, a ROM, a RAM, a hard disk unit, etc., and each may be a computer system that includes a portion of these.

(17) A portion or all of the constituent elements of the devices of the above embodiments and variations may be structured as a single system LSI (Large Scale Integration). A system LSI is a super multifunctional LSI manufactured by integrating a plurality of structural units onto a single chip. Specifically, it is a computer system including a microprocessor, a ROM, a RAM, and the like. A computer program is stored in the RAM. The system LSI achieves its functions as the microprocessor operates in accordance with the computer program.

Also, various portions of the constituent elements of the devices described above may be realized as individual chips, or partially or entirely realized as a single chip. Also, although an LSI is described here, the integrated circuit generated as described above may also be referred to as an IC, a system LSI, a super LSI, or an ultra LSI, depending on the degree of integration.

Also, the method of integration is not limited to being LSI technology, and may be realized by a dedicated circuit or by a general-purpose processor. The use of a field programmable gate array (FPGA) that can be programmed after LSI manufacture, or a silicon flexible processor in which the connection and settings of circuit cells in the LSI can be restructured, is also possible.

Furthermore, if integration technology is developed that replaces LSIs due to progressive or derivative semiconductor technology, integration of functional blocks using this technology is naturally possible. For example, the adaptation of biotechnology is a possibility.

(18) A portion or all of the constituent elements of the devices described above may be structured as a removable IC card or stand-alone module. The IC card or the module is a computer system including a microprocessor, a ROM, and a RAM, etc. The IC card and the module may include the above super multifunctional LSI. The IC card and the module achieve their functions as the microprocessor operates in accordance with the computer program. This IC card or module may be tamper resistant.

(19) The present invention may be the methods shown above. Also, the present invention may be computer programs for causing computers to realize the methods, or may be digital signals representing the computer programs.

Also, the present invention may be a computer-readable recording medium such as a flexible disk, a hard disk, a CD-ROM, an MO, a DVD, a DVD-ROM, a DVD-RAM, a BD (Blu-ray Disc), or a semiconductor memory on which the computer programs or the digital signals are stored. The present invention may be the computer programs or the digital signals which are stored on these recording media.

Also, the present invention may be the computer programs or digital signals which are transmitted via an electronic communications circuit, a wireless or fixed-line communications circuit, a network such as the Internet, a data broadcast, etc.

Also, the present invention may be a computer system including a microprocessor and a memory, whereby the memory stores the computer programs, and the microprocessor operates in accordance with the computer programs.

Also, the present invention may be carried out by another independent computer system by transferring the programs or the digital signals which have been stored on the recording media, or by transferring the programs or the digital signals via the network, etc.

(20) The present invention may be any combination of the above embodiments and variations.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A content playback device that controls playback of a content having embedded therein a plurality of watermark information pieces, each type of watermark information piece corresponding with each of a plurality of predetermined playback restrictions, the content playback device comprising:
a detection unit operable to detect a watermark information piece in the content;
a storage unit operable to store therein a history of detection results for a type of watermark information;
a control unit operable to execute a playback restriction corresponding to a type of watermark information piece for which a stored history of detection results satisfies a predetermined condition;
a judgment unit operable to, in a case that a watermark information piece has been detected, compare an extent of the playback restriction corresponding to a type of the currently detected watermark information piece to an extent of the playback restriction corresponding to the type of watermark information piece for which the history of detection results has been stored, and to judge, based on a result of the comparison, whether or not a detection result for the currently detected watermark information piece is to be stored in the storage unit; and
an update unit operable to, when the judgment unit judges affirmatively, store the detection result for the currently detected watermark information piece in the storage unit.

2. The content playback device of claim 1, wherein
the judgment unit judges that the detection result for the currently detected watermark information piece is to be stored in the storage unit when the extent of the playback restriction corresponding to the type of the currently detected watermark information piece is stricter than the extent of the playback restriction corresponding to the type of watermark information for which the history of detection results has been stored in the storage unit.

3. The content playback device of claim 1, wherein
each watermark information piece is in correspondence with a priority, and
the judgment unit judges that the detection result for the currently detected watermark information piece is to be stored when a priority of the currently detected watermark information piece is greater than a priority of the playback restriction corresponding to the type of watermark information for which the history of detection results has been stored, regardless of the extent of the playback restriction corresponding to the type of the currently detected watermark information piece.

4. The content playback device of claim 1, wherein
the judgment unit judges that the detection result for the currently detected watermark information piece is to be stored when the extent of the playback restriction corresponding to the type of the currently detected watermark information piece is different from the extent of the playback restriction corresponding to the type of watermark information for which the history of detection results has been stored in the storage unit.

5. The content playback device of claim 1, wherein
the update unit is further operable to, when a watermark information piece for a stored detection result is different from the currently detected watermark information piece, delete the stored detection result, and store the detection result for the currently detected watermark information piece.

6. The content playback device of claim 1, wherein
the content is constituted from a plurality of blocks,
the detection unit is further operable to judge for each block, in a playback order of the plurality of blocks, whether a watermark information piece has been embedded, and
the update unit stores, as detection results, a judgment result for each block indicating whether a watermark information piece has been embedded.

7. The content playback device of claim 6, wherein
the control unit executes a playback restriction corresponding to the type of watermark information when greater than or equal to a predetermined percentage of the judgment results show that the watermark information piece has been embedded.

8. The content playback device of claim 1, wherein
the storage unit stores a plurality of detection results for a plurality of watermark information pieces,
the update unit is further operable to additionally store, in the storage unit, the detection result for the currently detected watermark information piece when the judgment unit judges that the detection result for the currently detected watermark information piece is to be stored, and
the control unit is further operable to determine a playback restriction to execute, among the plurality of playback restrictions, in accordance with the plurality of detection results for the plurality of watermark information pieces stored in the storage unit.

9. A content playback method for controlling playback of content having embedded therein a plurality of watermark information pieces, each type of watermark information piece corresponding with each of a plurality of predetermined playback restrictions, the content playback method comprising the steps of:
detecting a watermark information piece in the content;
storing a history of detection results for a type of watermark information;
executing a playback restriction corresponding to a type of watermark information for which a stored history of detection results satisfies a predetermined condition;
comparing, in a case that a watermark information piece has been detected, an extent of the playback restriction corresponding to a type of the currently detected watermark information piece to an extent of the playback restriction corresponding to the type of watermark information for which the history of detection results has been stored, and judging, based on a result of the comparison, whether a detection result for the currently detected watermark information piece is to be stored in the storage unit; and
when the judgment unit judges affirmatively, storing the detection result for the currently detected watermark information piece in the storage unit.

10. A content playback program used by a content playback device that controls playback of content having embedded therein a plurality of watermark information pieces, each type of watermark information piece corresponding with each of a plurality of predetermined playback restrictions, the content playback program comprising the steps of:
detecting a watermark information piece in the content;
storing a history of detection results for a type of watermark information;
executing a playback restriction corresponding to a type of watermark information for which a stored history of detection results satisfies a predetermined condition;
comparing, in a case that a watermark information piece has been detected, an extent of the playback restriction corresponding to a type of the currently detected watermark information piece to an extent of the playback restriction corresponding to the type of watermark information for which the history of detection results has been stored, and judging, based on a result of the comparison, whether or not a detection result for the currently detected watermark information piece is to be stored in the storage unit; and
when the judgment unit judges affirmatively, storing the detection result for the currently detected watermark information piece in the storage unit.

11. An integrated circuit that controls playback of content having embedded therein a plurality of watermark information pieces, each type of watermark information piece corresponding with each of a plurality of predetermined playback restrictions, the integrated circuit comprising:
a detection unit operable to detect a watermark information piece in the content;
a storage unit operable to store therein a history of detection results for a type of watermark information;
a control unit operable to execute a playback restriction corresponding to a type of watermark information for which a stored history of detection results satisfies a predetermined condition;
a judgment unit operable to, in a case that a watermark information piece has been detected, compare an extent of the playback restriction corresponding to a type of the currently detected watermark information piece to an extent of the playback restriction corresponding to the type of watermark information for which the history of detection results has been stored, and to judge, based on a result of the comparison, whether or not a detection result for the currently detected watermark information piece is to be stored in the storage unit; and
an update unit operable to, when the judgment unit judges affirmatively, store the detection result for the currently detected watermark information piece in the storage unit.
